(19) United States
(12) Patent Application Publication
(10) Pub. No.: US 2016/0210705 A1
(43) Pub. Date: Jul. 21, 2016

(54) USER BENEFIT ALLOCATION SYSTEM

(71) Applicant: Trophy Profile, Salt Lake City, UT (US)

(72) Inventor: Aaron Florian, Pleasanton, CA (US)

(21) Appl. No.: 14/997,343

(22) Filed: Jan. 15, 2016

Related U.S. Application Data
(60) Provisional application No. 62/105,570, filed on Jan. 20, 2015.

(51) Int. Cl. G06Q 50/00; G06Q 30/02

(52) U.S. Cl. CPC G06Q 50/01; G06Q 30/0212

(57) ABSTRACT

An interactive, network-based computer system for intelligently distributing a quantifiable resource among a group of electronic accounts can be configured to store a user-behavior value. The system can also be configured to receive through an API an indication that the user-behavior value associated with a user should be incremented by a user-behavior value increment. The received communication can be validated. Upon being validated, the user-behavior value can be incremented.

### CROSS-REFERENCE TO RELATED APPLICATIONS

This application claims priority to and the benefit of U.S. Provisional Application Ser. No. 62/105,570, entitled “Trophy Profile”, filed on Jan. 20, 2015, the entire contents of which is incorporated herein by reference in its entireties.

### BACKGROUND OF THE INVENTION

1. Technical Field

The present invention relates to an interactive, network-based computer system.

2. Background and Relevant Art

Various resources, such as recreational activities, have a limited availability, such that not everyone who desires to participate is provided with an opportunity. The scarcity associated with these resources has only increased as global populations have ballooned. For example, many individuals enjoy hunting. In order to preserve hunted species at healthy and sustainable levels, it is necessary to limit the number of game animals that can be taken in a particular season. In some cases, only a few hundred licenses to hunt a particular type of animal may be available, despite tens of thousands of individuals seeking to obtain a license. Similar scarce resources are present in relation to other recreational activities, such as access-controlled hikes, guided tours, and other similar activities.

### BRIEF SUMMARY OF THE INVENTION

Implementations of the present invention relate to a computer system platform that allows users to interface with multiple other users while facilitating greater user interaction within the outdoor community. The social media platform can encourage participation by users in altruistic activities such as donating time, money and resources for the benefit and propagation of sustainable wildlife and other conservation objectives. The system can also intelligently distribute a scarce resource among various electronic user accounts.

Implementations of the present invention can comprise systems, methods, and apparatus for intelligently distributing a quantifiable resource among a group of electronic accounts. An exemplary system can comprise one or more processors and one or more computer-readable media having stored thereon executable instructions that are executable by the one or more processors to configure the computer system to perform various actions.

For example, the system can store within a user database one or more electronic accounts that are created by users. The electronic accounts comprise a first data object that includes information descriptive of each respective user and a second data object that includes a user-behavior value. The system can also receive through a validating interface API an indication that the user-behavior value associated with a user should be incremented by a user-behavior value increment.

The validating interface API can be configured to receive a network communication from a remote third-party computer system. The network communication can comprise a third-party identifier, a value, and a value type. The validating interface API can also be configured to validate the third-party identifier against a list of eligible third-parties. Additionally, after validating the third-party, the validating interface API can also be configured to identify within a value-type dataset a data element that is associated with the received value type. The data element can comprise a value multiplier. Further, the validating interface API can be configured to generate the user-behavior value increment by multiplying the received value with the value multiplier. Further still, the validating interface API can be configured to increment the user-behavior value by the user-behavior value increment.

The system can also receive from the user, associated with a particular electronic account, an indication of a particular geographic region and a particular desired objective. The system can then access, within a resource tracking database, a resource indicator that comprises data objects that correlate to both the particular geographic region and the particular desired objective. Additionally, the system can identify a scarcity factor associated with the resource indicator. The scarcity factor may indicate a number of available slots associated with the resource indicator. Further, the system can determine whether the user receives an available slot by calculating a randomized drawing value that is weighted by the user behavior value that is associated with the user's electronic account.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a conceptual diagram of a social media platform depicting a user interface which allows multiple users to interact within the system and encouraging an active level of participation within the system according to one aspect of the present invention;

FIG. 2 illustrates a conceptual diagram of a social media platform depicting a user interface having a member profile module, a documentary module, “share” module and a discover module according to one aspect of the present invention;

FIG. 3 illustrates a conceptual design of a resource allocation module having a point allocation system according to one aspect of the present invention;

FIG. 4 illustrates a conceptual design of a member participation program module of a social media platform according to one aspect of the present invention; and

FIG. 5 illustrates a logic flow diagram depicting a method of allocating resources according to one aspect of the present invention.

### DETAILED DESCRIPTION OF THE PREFERRED EMBODIMENTS

The ensuing description provides embodiments only, and is not intended to limit the scope, applicability or the configuration of the claims. Rather, the ensuing description will provide those skilled in the art with an enabling description for implementing the embodiments. It being understood that various changes may be made in the function and arrangement of elements without departing from the spirit and scope of the present invention.

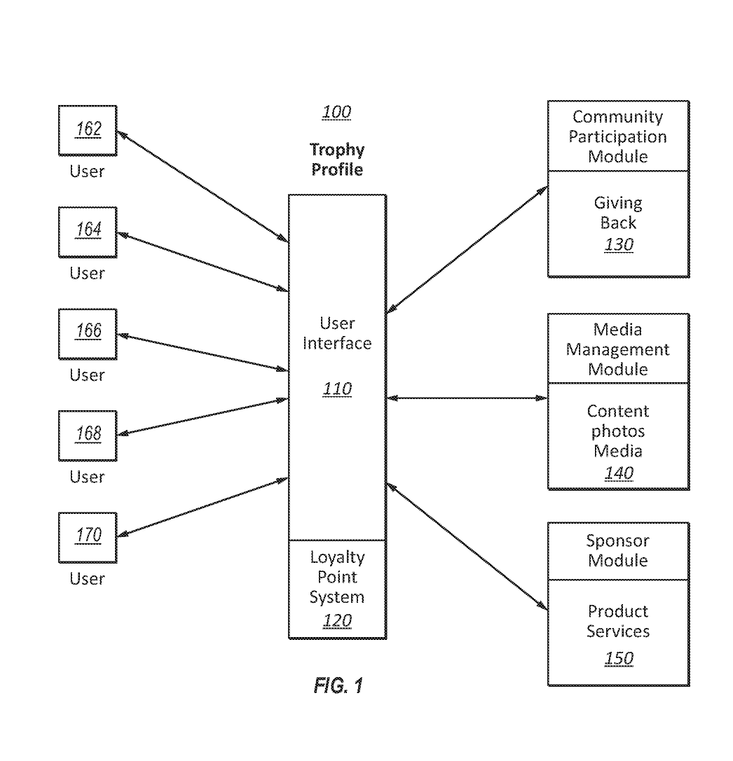

FIG. 1 illustrates an interactive, network-based, computer system in the form of a social media platform 100. The social media platform 100 allows multiple users to create electronic accounts and interact with other users. The social media platform 100 can encourage an active level of participation within the social media platform 100 according to one aspect of the present invention. Social media platform 100 allows for submission of user data, which can be attributed based on the program data. This allows for filtering, aggregation and utilization of data to improve a user's social media experience as part of a community. In the illustrated embodiment, social media platform 100 includes a user interface 110, a loyalty point system 120, a community participation module, a media management module 140 and a sponsor module 150. A plurality of users 162, 164, 166, 168 and 170 are also depicted.

User interface 110 can receive input from users 162-170 and provide output in the form of user submitted content. Content can include photos, video, biographical information and the like. For example, user 162 may submit information regarding the user's name, age, birth date, location, preferred outdoor activities, photos of hunting adventures, fishing trips, harvested hunting trophies, dates of harvest, size of animals harvested, score of antlers or other biographical information related to the harvest of the trophy. User 162 may then invite a friend 164 to participate in social media platform 100.

Upon registering, or otherwise accepting the invitation from user 162, user 164 may then view information related to the hunting adventure provided by user 162. User 164 may then discover that a second acquaintance, user 166 has already posted content related to fishing or another outdoor recreational activity. User 164 may then submit a request to user 166 to become an approved contact on social media platform 100. When user 166 confirms that user 164 is an approved contact, user 164 may then view approved content of user 164. Likewise, once user 164 submits information related to a recent outdoor adventure, for example a whitetail deer hunt in Kansas, user 166 may then view the approved information of user 164.

Loyalty point system 120 is provided in connection with user interface 110. Loyalty point system 120 monitors activity related to users 162-170 and assigns loyalty points to the accounts of users 162-170. The loyalty points may be stored within a data object that is associated with a particular user within the social network. For example, each user account may comprise a data object that stores a user-behavior value. A value stored within the user-behavior value data object can be incremented to include the loyalty points.

Loyalty points assigned by loyalty point system 120 can be used in drawings, coupons, discounts or other rewards based system to users 162-170. Loyalty points assigned by loyalty point system 120 can be based on user behavior is identified as desirable. For example, loyalty points can be assigned for: (1) purchases made on an e-commerce store on the social media platform 100 website: (2) submissions of posts, photos, video, comments or other interactions through user interface 110; or (3) altruistic behavior such as donations, participation in conservation projects, fundraisers or otherwise giving back to wildlife and the outdoors.

In the illustrated embodiment, community participation module 130 monitors users' participation in altruistic behavior. As previously discussed, this can include financial or in-kind donations to conservation related projects for non-profits who have a conservation mission. Points can also be awarded, and added to a user's user behavior value, by participation module 130 for performing on-the-ground conservation projects sponsored by state fish and game agencies, non-profit organizations, conservation trusts or other landowners. In another example, participation module provides points for volunteering for non-profits or helping with conservation fund-raisers.

These examples of giving back are provided for illustrative purposes and should not be considered to be limiting in scope. According to one illustrative embodiment of the present invention, participation module may assign points on a weighted system to encourage some forms of altruistic behavior over other forms of altruistic behavior. For example, during important issues campaigns, double points could be awarded for advocacy such as calling a Senator or Congressman or distributing informational literature. The weighted system can then utilize a multiplier when adding the points to a user's user-behavior value. As will be appreciated by those skilled in the art, a variety of types and combinations of altruistic or volunteer based activities can be awarded by community participation module 130 without departing from the scope and spirit of the present invention.

Media management module 140 is configured to allow users to submit bibliographic information. Bibliographic information may include a user's name, age, birth date, location, preferred outdoor activities, photos of hunting adventures, fishing trips, harvested hunting trophies, dates of harvest, size of animals harvested, score of antlers or other biographical information related to the harvest of the trophy.

Media management module 140 interacts with user interface 110 such that the bibliographic information is available to the user who submitted the information in the first instance. Privacy settings, access control and other tools can be provided in a manner which allows the user full control over which information is available to authorized contacts, general users and the general public. In this manner, media management module 140 module and user interface 110 can allow the user to document a highly detailed amount of information related to outdoor experiences, such as harvest of a trophy deer without concern that all the data, photos, video and the like recorded within the system will be viewable to the general public.

Varying levels of privacy controls may be selected by a user to protect or manage access to such information. For example, the general public may be authorized to see that a user has harvested 3 black bears. However, the photos of the bears harvested, weight and measurements of the bear may only be available to authorized contacts. Finally, information regarding the skull measurements, age and exact location of harvest may only be viewable by the user who submitted the data on his/her profile page. According to one embodiment of the present invention, the privacy setting for categories of information related to an outdoor experience are user defined during the submission of the data, but can be modified at a later date if desired.

According to one illustrative embodiment of the present invention, submission of content in association with user interface 110 and media management module 140 is coordinated with loyalty point system 120. In this manner, loyalty points can be awarded for participation in social media platform 100. Points may be awarded based on the number of views of a particular post, photo, video or other data. According to another embodiment of the present invention, the number of “likes” or “shares” of a user submitted information can result the award of additional bonus points which are above and beyond standard point awarded to users. In yet another embodiment, only particular categories of participation or generally viewable photos are awarded points. In this manner, loyalty point system 120 can interact with user interface 110 and media management module 140 to ensure that points are awarded for interactions within social media platform 100 which enhance or otherwise improve the viewing experience for the entire user community.

A sponsor module 150 is also depicted. Sponsor module 150 monitors user purchase of selected products, sponsor products and services, industry events or otherwise support companies that are supportive of the social media platform 100 provider or the outdoor industry in general. According to one illustrative embodiment of the present invention, sponsor module 150 interacts with loyalty point system 120. As a user purchases product, supports industry sponsors or otherwise engages in desirable activities through user interface 110 which are monitored by sponsor module 150, loyalty points are awarded by loyalty point system 120 to the user.

According to one aspect of the system, one or more of community participation module 130, media management module 140 and sponsor module 150 monitor activities of user in user interface 110 and provide data to loyalty point system 120 which results in incrementing a user's user-behavior value within the system. According to another embodiment of the present invention, each of community participation module 130, media management module 140 and sponsor module 150 interact with loyalty point system 120 to provide loyalty points to users for community participation, media submissions or other social interactions within the user interface and purchasing products from or otherwise supporting sponsors and industry sponsors.

According to one aspect of the present invention, user-behavior values can be utilized to distribute a scarce resource to users of social media platform 100. For example, in the event that the scarce resource is a fully paid, guided hunting adventure in Canada, users having higher user-behavior values would be given additional entries in a drawing for the hunting adventure if they have a higher user-behavior value. Alternatively, the user's odds of being the winner of the drawing would be improved if they have a higher user-behavior value. According to another embodiment of the present invention, a user could allocate a portion of his or her user-behavior value to a particular drawing to improve their odds of being the winning recipient of the drawing. Alternatively, points could be expended to obtain outdoor products, services, discounts or coupons for outdoor gear. It will be appreciated by those skilled in the art these examples are provided for illustrative purposes and the manner in which the resource allocation module distributes limited or scarce resources using weighting, points or other predetermined factors can vary without departing from the scope and spirit of the present invention.

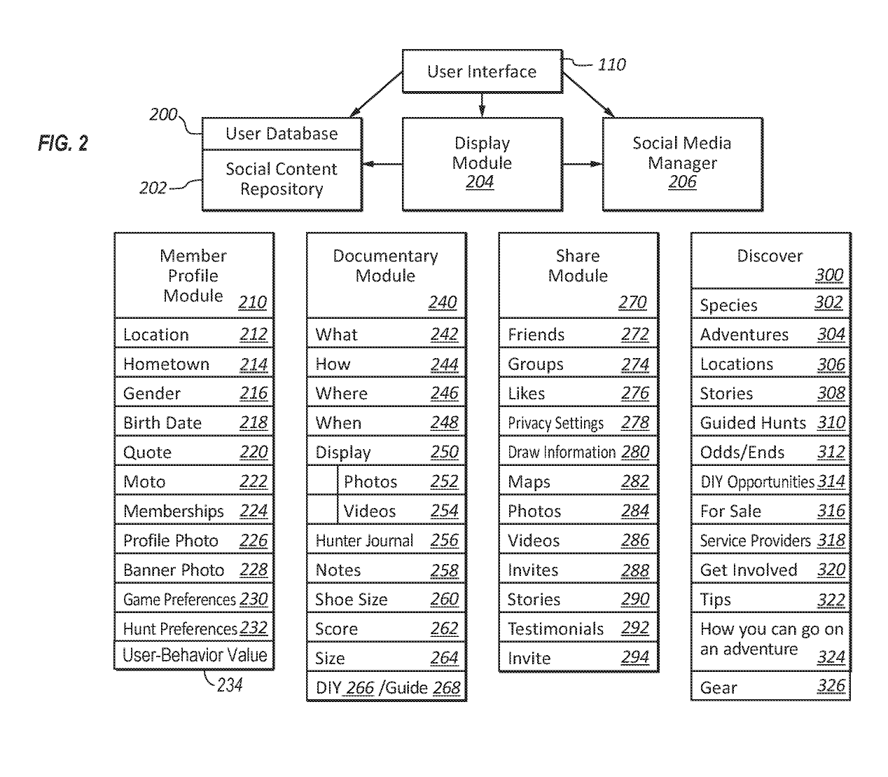

FIG. 2 illustrates social media platform 100 according to one aspect of the present invention. In the illustrated embodiment, social media platform 100 is configured to allow a user to: (1) input information related to a user profile; (2) document information related to outdoor adventures; (3) control the manner in which the information is shared with third parties; and/or (4) explore information related to new outdoor adventures.

Social media platform 100 includes a user interface 110, a user database 200, a social content repository 202, a display module 204 and a social media management 206. User database 200 stores data related to each user, user profile and/or user submitted content. In this manner, user interface 110 can accept, store and display user submitted content. User database stores content as data that can be accessed through user interface 110. Data can include attributes which allows for filtering, aggregation, management and utilization of the content in a way to enhance a user's access to content and overall user experience.

User database 200 includes a social content repository 202. Social content repository 202 stores and allows for active management and utilization of social media related content, such as photos, videos and the like. Display module 204 interacts with user database 200 and user interface 110 to allow access to and display of user submitted content. A social media manager 260 allows a user to actively manage the storage, access to and display of user submitted content. In other words, user database 200, display module 204 and social media manager 206 allow for the storage, display and active management of user submitted content through user interface 110.

A member profile module 210, documentary module 240, share module 270 and discover module 300 are provided in connection with social media platform 100. Documentary module 240, share module 270 and discover module 300 interact with user database 200, display module and social media manager 206 to allow a user to input biographical information, trophy/outdoor adventure related information, while also controlling access to and display of user submitted information. Documentary module 240, share module 270 and discover module 300 interact with user database 200, display module and social media manager 206 to allow a user to explore new information related to outdoor adventures, gear and other community involvement.

In the illustrated embodiment, member profile module 210 includes a variety of attributed data associated with the user of the system. According to one embodiment of the present invention, the attributed data can be filtered from and/or aggregated with other user submissions. In the illustrated embodiment, member profile module 210 includes location content 212, hometown content 214, gender content 216, birth date content 218, quote content, 220, motto content, memberships content 224, profile content 226, banner photo content 228, game preferences content 230, hunt preferences content 232 and a user-behavior value 234.

Location content 212 relates to information associated with a user's address, workplace or other data associated with the user's location. This allows friends and other users to determine where a particular person resides for purposes of identification, networking or other well-established social media norms. In at least one embodiment, the location content 212 can also be used to automatically match a user with proposed benefits, such as hunting trips, guided trips, hunting licenses, guided hikes, etc. Hometown content 214 relates to information associated with the town, city, county or region where a person was born, grew-up or otherwise is affiliated. This can be particularly helpful for understanding a person's upbringing, affiliations, preferred outdoor activities. For example, a person who was raised in the south or Midwest may prefer bass fishing and whitetail hunting, while a person who is raised in the Northern Rockies prefers trout fishing and elk hunting. Information related to a hometown may make it easier for old friends to find and connect with a person with whom they grew-up.

Additional biographical information is provided by gender content 216 and birth date content 218. A person may provide quote content 220 and motto content 222 to provide additional flavor to the user's profile. For example a person who is a dedicated fisherman might have a quote from a famous fisherman such as Earnest Hemingway, whereas a dedicated conservationist might have a quote from a famous conservationist like Teddy Roosevelt. This type of content can provide additional perspective into a person's outlook on life, core-principles or other way of thinking to provide additional interest above and beyond simple biographical information.

Membership content 224 allows a user to submit information of conservation groups, non-profits, clubs or other affiliations in the outdoor world to which they belong. Profile photo content 226 and banner photo content allows a user to provide user submitted photos to provide a desired look and feel to their user's profile page. Game preferences content 230 contains information related to the preferred wild game hunting preferences such as “big game”, “upland game,” “deer,” “trout” to document the game or type of hunting preferred by the user. Hunt preferences content 232 allows a user to select the type of hunting preferred such as rifle, archery, shotgun or other “methods of take” preferred by the user.

User-behavior value 234 can comprise a data object for storing a user specific user-behavior value (also referred to herein as “loyalty points”). The user behavior value 234 may comprise a value that is incremented based upon user actions, such as donations, participation in the social network, service activities, and other related user activities. The user-behavior value 234 can also be decremented based upon the value (i.e., “loyalty points”) being expended on a particular objective. For example, the user may purchase an item using his or her loyalty points. Similarly, a user may expend at least a portion of his or her loyalty points to increase their chances in a drawing for a limited resource, such as a hunting trip.

As will be appreciated by those skilled in the art, location content 212, hometown content 214, gender content 216, birth date content 218, quote content, 220, motto content, memberships content 224, profile content 226, banner photo content 228, game preferences content 230, hunt preferences content 232 and user-behavior value 234 are provided for illustrative purposes. The exact type and configuration of content can be selected from a variety of bibliographic or outdoor oriented criteria without departing from the scope and spirit of the present invention.

Documentary module 240 allow a user to document details regarding a harvested trophy or outdoor experience. Documentary module 240 interacts with user database 200 to allow desired interaction with user interface 110 to store and display information regarding a user's trophy or outdoor experience to the user and/or to other users of social media platform 100. Documentary module includes a variety of attributed data associated with outdoor experiences such as fishing, hunting and other outdoor adventures.

According to one embodiment of the present invention, the attributed data can be filtered and aggregated from other user submissions. Documentary module 240 includes a what content 242, how content 233, where content 246, when content 248, display content 250, photos content 250, photos content 252, video content 254, hunter journal 256, notes content 258, tools of harvest content 260, score content 262, size content 264 and guide content 268.

Content 242-268 allows a user to record journal type content related to the exact information for a fishing, hunting or outdoor experience. For example, in the event a user harvests a mountain goat in British Columbia, documentary module 240 allows the user to record what was harvested with what content 242. How the mountain goat was harvested can be recorded with how content 233. Where the mountain goat was harvested can be recorded with where content 246. When the mountain goat was harvested can be recorded with when content 248. Display content 250 allows the user to select photos and video to display using photos content 252 and video content 254. Additional notes regarding the trip can be recorded with notes content 258. The tools of harvest such as the rifle, caliber, bullet, bow, arrow, broadhead etc. can be recorded for future reference with tools of harvest content 260. Score content 262 allows the overall score or other dimensions of the mountain goat to be recorded into user database 200. Similarly the size of the mountain goat can be recorded with size content 264. DIY content 266 allows the user to identify if the harvest was conducted on a “Do It Yourself” hunt or situation, whereas guide content 268 allows information related to a guided/outfitted hunt to be recorded.

As will be appreciated by those skilled in the art, what content 242, how content 233, where content 246, when content 248, display content 250, photos content 250, photos content 252, video content 254, hunter journal 256, notes content 258, tools of harvest content 260, score content 262, size content 264 and guide content 268 are provided for illustrative purposes. The particular information or recordation modules provided with the documentary module for recording information related to a fishing trip, hunting harvest, or other outdoor adventure can be selected without departing from the scope and spirit of the present invention.

Share module 270 allows a user to define settings allowing access to and/or control of user generated content with approved contacts. Share module 270 is connected to display module 204 and social media manager 206 allowing the user defined attributes provided in connection with share module 270 to be shared or protected by user interface 110 with third parties. For example, a user may define parameters allowing some photos to be viewable by any third party. A second set of parameters are defined such that a second set of photos is viewable only by approved contacts such family and close friends. A third set of parameters is defined such that a third set of photos is only available to the user himself or herself.

In the illustrated embodiment, share module 270 includes a variety of attributed data associated with outdoor experiences such as fishing, hunting and other outdoor adventures. According to one embodiment of the present invention, the attributed data can be filtered and aggregated from other user submissions. In the illustrated embodiment, share module 270 includes friends content 272, groups content 274, likes content 276, privacy settings 278, draw information 280, maps content 282, photos settings 284, video settings 286, invitees settings 288, stories settings 290, testimonials settings 292, invite settings 294.

According to one aspect of the present invention, friends content 272, groups content 274, likes content 276, privacy settings 278, draw information 280, maps content 282, photos settings 284, video settings 286, invitees settings 288, stories settings 290, testimonials settings 292, invite settings 294 provide attribute settings which define accessibility or privacy settings for other data. For example, photo settings 284 allows a user to define parameters related photos provided through photo content 253 of documentary module 240. For example, when a user uploads a photo through photo content 252, documentary module 240 permits the photo to be loaded to user database 200. A user then can allow previously defined privacy parameters defined by photo settings 284 through share module 270 to apply to the newly uploaded photo. Alternatively, the user can specify new privacy parameters through photo settings 284 of share module 270 for that particular photo. For example, a user's privacy setting may allow all photos to be viewable only by approved contacts such as family and friends. However, a user may decide to make the photo viewable to all third parties, or alternatively, fully private and viewable only by the user.

According to another aspect of the present invention, friends content 272, groups content 274, likes content 276, privacy settings 278, draw information 280, maps content 282, photos settings 284, video settings 286, invitees settings 288, stories settings 290, testimonials settings 292, invite settings 294 allow the user to input additional data, content or information which is not provided in connection with member profile module 210 or documentary module 240. For example, maps content 282 can allow a user to input a topographic, road or geographic map associated with a given outdoor adventure. In one illustrative embodiment, maps content 282 permits a user to input a map illustrating harvest locations for wild game in a favorite hunting area. In another embodiment, a user can input a map and identify locations of trail camera locations, photos, wild game sighting and other user defined attributes.

In at least one embodiment, the various data can then be automatically aggregated to across the social network to determine travel patterns, feeding patterns, the use of water sources, likely tree stand or ground blind locations, or other useful data. For example, an aggregator within the system can search for posts with geographic coordinates from the region. The aggregator can then intelligently parse the data based upon species type, data type, and date to determine the travel path of specific species, the travel and location of hunters, and predicted future locations of hunters and the particular species. In another embodiment, a user can input a map and identify places where fish were caught, the weight of the fish, the weather patterns, water temperature and other useful data to improve an anglers chance of catching large fish or otherwise improving angling success.

In the illustrated embodiment, friends content 272 allows a user to identify other users of social media platform 100 that the user personally knows or is otherwise affiliated with. Groups content 272 allows for identification and organization of like-minded users to affiliate, share content and otherwise interconnect using social media platform 100. Likes content 276 includes data, which can be utilized to perform a variety of functions. For example, in one embodiment, likes content 276 track instances in which a user tags social media content within social media platform 100. In another embodiment, likes content 276 monitors attributes of content tagged by a user allowing the attributes to be filtered and aggregated. In this manner, share module 270 can apply filter criteria to social media within user database 200 to point the user to similar content on social media platform 100.

Privacy settings 278 allows a user to set privacy criteria to his personal page, user submitted content such as biographical information, photos and video and information related to outdoor adventures, trophy harvest or other information. As previously discussed, privacy settings 278 can be generally set parameters applying to all user submitted data within a given category, or privacy parameters can be defined separately for information such as a new photos or video. Draw information 280 can allow a user to record information on state or provincial hunting applications for limited entry drawings, preference points, draw odds and the like. In this manner, the user can monitor the likelihood of drawing a desired permit, the length of time for future permit drawings as well as additional parameters such as application deadlines, costs etc. In this manner, the user can utilize the social media platform as an organizational tool to pursue new hunting, fishing or outdoor adventures.

Maps content 282 allows a user to upload, download or otherwise associate a map with their webpage. Maps can provide an overview of hunting adventures taken internationally, nationally or harvest of animals within a favorite hunting area. Maps can also be utilized to show an epic road trip, hiking excursion or otherwise track, monitor or quantify an outdoor experience. Maps content 282 can allow a user to place a pinpoint, trace a trail, or show a route traveled. Photos settings 284 allows a user to set privacy settings in relation to a particular photo or set of photos. Photo settings 284 can also allow a user to define storage size, edit photos or otherwise provide tools for optimal photo storage and retrieval. Video settings 286 allows a user to set privacy settings in relation to a particular photo or set of photos. Video settings can allow a user to define a storage size, edit photos or otherwise provide to tools for optimal video storage and retrieval.

Invitees setting 288 monitors information related to users' invitations to other users of the system to allow authorized access to a user's content. Invitees settings 288 can also monitor a users request for other users to become a “friend” or authorized friend of the user's content. Invitees setting 288 may also filter attributes to identify potential family, friends or other users who the user may be affiliated and suggest those as potential invitees. Stories settings 290 allows a user to input and/or define settings related to stories which are stored in the system. Testimonials settings 292 allows a user to input and/or define settings related to testimonials within the system. Such testimonials may relate to statements from companions on a hunt, be statements related to a particular guide or outfitter, or relate to hunting a particular area. Invite settings 294 may allow a user to define settings in relation to invitations to other users of the system, or invite non-users of the system to join the social media platform. Alternatively, invite settings 294 may correspond with a system that requires new users to be invited by existing users of the system before they will be allowed access to membership on the social media platform.

Discover module 300 allows users to access information related to new outdoor adventures including detailed information for planning and implementing new excursions. Discover module 300 is connected with user database 200, display module 204 and social media manager 206. Discover module 300 includes a variety of attributed data associated with outdoor experiences such as fishing, hunting and other outdoor adventures. According to one embodiment of the present invention, the attributed data can be filtered and aggregated from other user submissions. For example, if users are interested in hunting stone sheep in the Yukon, all users who have submitted photos, video or testimonials from hunts with a particular outfitter can be aggregated to allow users to explore the various aspects of hunting with that particular outfitter. According to yet another embodiment of the present invention, system provided information can be utilized to populate data associated with discover module 300. In yet another embodiment, a combination of system provided information and user provided data is utilized.

In the illustrated embodiment, discover module 300 includes species content 302, adventures content 304, locations content 306, stories content 308, guided hunt content, odds and ends content 312, Do It Yourself (“DIY”) opportunities content 314, for sale content 316, service providers content 316, get involved content 320, tips content 322, how you can go on an adventure content 324 and gear content 326. Content 302-326 includes attribute data that can be translated, filtered or otherwise aggregated to ascertain understandable structures for further use. For example, if it is determined that “wilderness elk hunting” or “trophy mule deer” are highly sought after information by system users within the discovery module 300, additional information on tips and techniques, hunt units, guides and outfitters, or other information can be provided to enhance user's experience. Additionally, content submitted from users that have extensive knowledge, experience or tips for these categories of adventures can be made available with user permission. Alternatively, groups, which cater to these categories, can be suggested to other users to enhance opportunities to request information, exchange ideas or otherwise allow users to explore a depth and vast level of knowledge with respect to a particular category. In other words, attributed data sets and system filter and aggregation can utilize predictive analytics to more accurately support a user's areas of research, interest or otherwise allow them to increase their level of specialized knowledge.

Species content 302 includes data associated with different species of fish and game. For example, information on huntable African wildlife species can be provided utilizing species content 302. This can include a species range, physical characteristics, color variations, areas where they can be hunted, trophy qualities etc. Adventures content 304 includes data associated with different species of fish and game. Adventures content 204 allows users to research information on availability, sources and details related to such outdoor adventures. For example, if a hunter determines that they are interested in hunting Livingstone's Eland, hunting concessions, outfitters, and details related to hunting these Eland can be researched and explored.

Locations content 306 includes data associated with countries, provinces, states, and localities where a particular outdoor adventure might be pursued. This can allow users to explore additional information related to a location where a particular adventure can be pursued. For example, if a person is planning to fish for Peacock bass, information related to Brazil, Brazilian culture, food, customs and travel can be provided by locations content 306. Stories content 308 includes data associated with stories of particular outdoor adventures. Stories content 308 allows users to read other individuals experiences hunting, fishing or exploring areas where they wish to travel, hunt or fish.

Guided hunt content 310 includes data associated with professional guided hunting operations. Guided hunt content 310 allows users to explore different outfitters who offer hunting, fishing or outdoor excursions in a particular area, for a particular species or who may otherwise be hired by a user. Odds and ends content 312 includes data related to interesting experiences, facts or other information, which may interest, inform or otherwise entertain a user. Do It Yourself (“DIY”) opportunities content 314 includes data related to adventures which can be self-guided or conducted without professional assistance. Do It Yourself Opportunities 314 allows users to explore opportunities for outdoor adventures, gear, travel, or other planning needs for conducting the trip and other helpful information.

For sale content 316 includes data related to products, services and other items, which are available for sale. For sale content 316 can allow users to post items for sale, browse items for sale or otherwise engage in buying and selling of items, particularly outdoor related products and services. Service providers' content 316 includes data related to individuals or companies that provide specialized or particular services. Service providers' content 316 allows a user to explore service providers, which can be utilized by the user. For example, a user can research service providers, which may offer horseback outfitting for a particular area or species. Alternatively, service providers can offer their services to individual who are looking for particular services.

Get involved content 320 contains data pertaining to a user's availability to get more involved with a particular area of interest, non-profit organization, or otherwise increase the user's level of involvement in the outdoor community. Tips content 322 contains data on information on methods, tactics, gear or other knowledge related to the outdoor space. Users who are exploring a particular area of interest can discover new tips, tactics, and techniques to become more knowledgeable or otherwise learn how to do things differently.

How you can go on an adventure content 324 includes data which enable users to purse new outdoor adventures. Gear content 326 includes data related to different outdoor gear. Gear content 326 can include specifications, uses, alternatives, reviews, photos and other information which allows users to ascertain gear which can be utilized for hunting, fishing, backpacking, exploring or other outdoor adventures.

As will be appreciated by those skilled in the art, content 302-326 are provided for illustrative purposes and should not be considered to be limiting in scope. A variety of types and configurations of content can be associated with a discover module without departing from the scope and spirit of the present invention. Additionally, different forms and functionality can be provided with a discover module. For example, in one embodiment, each of the various content areas are associated with aggregation, filtering or other parsing functionality to allow for analysis of large quantities of data extraction and repurposing. In another embodiment, each content area can include a manager, which allows access, uploading and browsing of user defined information based on the privacy settings of the system. According to another embodiment of the present invention, the particular content made most readily available to a user is based on the users biographical information, interests and passions.

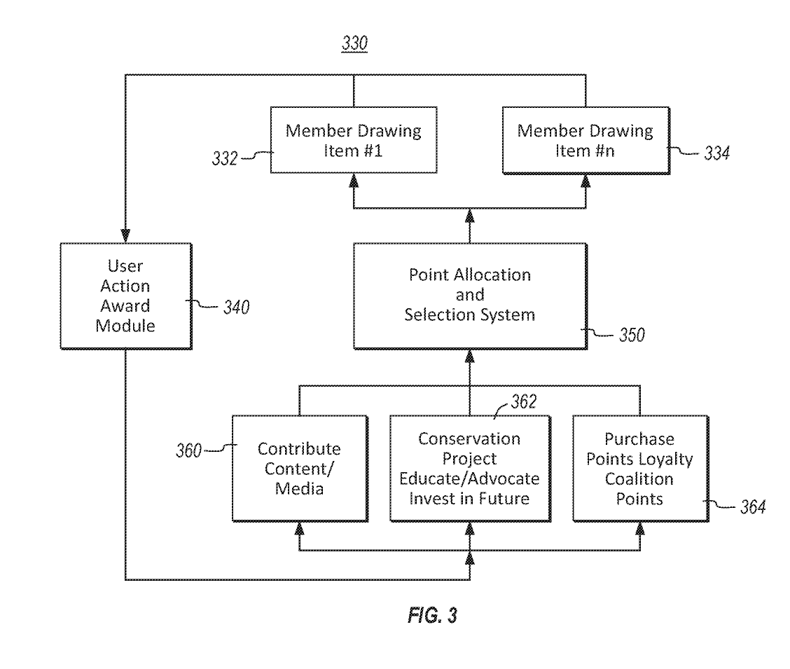

FIG. 3 illustrates a conceptual design of a resource allocation module 310 having a point allocation and selection system 350 according to one aspect of the present invention. In the illustrated embodiment, resource allocation module 330 is configured to distribute a limited or scarce resource to users of the system. The resource allocation module is configured to make selection of a recipient user of the resource based on weighted factors and randomization criteria, wherein a user's likelihood of being selected improves based on weighted factors, but in the preferred embodiment ultimately selection occurs through a randomized process. Resource allocation module 330 includes a user action award module 340, a media contribution module 360, a conservation module 362, a loyalty module 364, and a point allocation system 350.

In the illustrated embodiment, a user's activity within the social media platform is tracked using media contribution module 360, conservation module 362 and loyalty module 364. Media contribution module 360 monitors the user activities related to posting of photos, videos, comments, or other activity with respect to his/her own social media content or the contributions of others. For example, in the event that a user posts information on a fishing trip to Brazil, including photos, stories, narratives or video, media contribution module 360 will track such usage. Conservation module 362 provides a mechanism for tracking a user's contributions to conservation of wildlife, fish or habitats. This can include participation in an on-the-ground conservation project, helping at a fundraiser, making a financial contribution to a project or non-profit organization in the field of wildlife conservation, send a letter to Congress or working on a petition to support conservation. It could also involve purchase of products which provide a percentage to wildlife conservation through regulatory channels or at a fundraiser. Conservation module 362 allows a user to track such contributions to outdoors, wildlife and the North American Model of Wildlife Conservation.

Loyalty module 364 tracks a user's activity on social media platform outside of conservation or contribution of media. For example, if a user refers a friend to become a member, loyalty module 364 can track this contribution to the social media platform. Similarly, joining a partner conservation organization of the social media platform can be monitored by loyalty module 364. Another example is the purchase of product or services from sponsors of social media platform. For example, buying a sweatshirt, which is offered for sale on social media platform, or a guided outdoor trip from a sponsor outfitter can be tracked by loyalty module 1008.

Point allocation system 350 can assign loyalty points, money, drawings or miles or other awards units to the user. This can be based on one or more of contributions to social media tracked through media contribution module 360, contributions in the field of conservation or charitable giving tracked through conservation module 362 or loyalty activities such as referrals, purchases, clicks, or goods and services monitored through loyalty module 364.

A membership drawing item 332 and a membership drawing item 334 are depicted in FIG. 3. Membership drawing item 332 is depicted as a membership drawing item #1. Membership drawing item 334 is depicted as a membership drawing item #n. This conveys that a plurality of different membership drawing items could be selected as will be understood by those skilled in the art. Exemplary drawing items could include, but are not limited to, boots, fishing poles, archery equipment, flashlights, redeemable travel, airfare, lodging, guided fishing trips, guided hunting trips, or other goods and services. Membership drawing items can be dispersed in a number of ways or at a number of intervals including, but not limited to, as benchmarks are reached, when they are available, monthly or as special incentives, or a combination of different ways.

Membership drawing items 332 and 334 are allocated using point allocation/selection system 350. In this manner, a user's loyalty points are used to include them in a randomized drawing for membership drawing items 332 and 334. The users' participation in social media platform and monitored by media contribution module 360, conservation module 362 and loyalty module 364 are utilized by the point allocation/selection system 350 to select a recipient of the drawing items 332 and member drawing item 334. User attributed data can be utilized to correlate membership drawing items with certain interest items. For example, a user's whose interest relates particularly to photography of live animals can be entered for drawings for camera equipment, video cameras, editing software, tripods, photo safaris or the like. A user who has an interest in upland game hunting can be entered in drawings for field dog training, shotguns, South Dakota Pheasant hunting trips or the like. Similarly, a person whose interest is primarily in offshore fishing can be entered for saltwater fishing reels, heavy poles, airfare to ocean fishing destinations and the like.

In this manner, membership drawings can be used to increase interest, loyalty and participation in the program. It can also appeal to a user's particular passions and interests in the field of hunting, fishing and outdoor recreation. The system can also foster involvement and contribution of content to the social media platform, conservation and loyalty to sponsors, advertisers and partners of the social media platform.

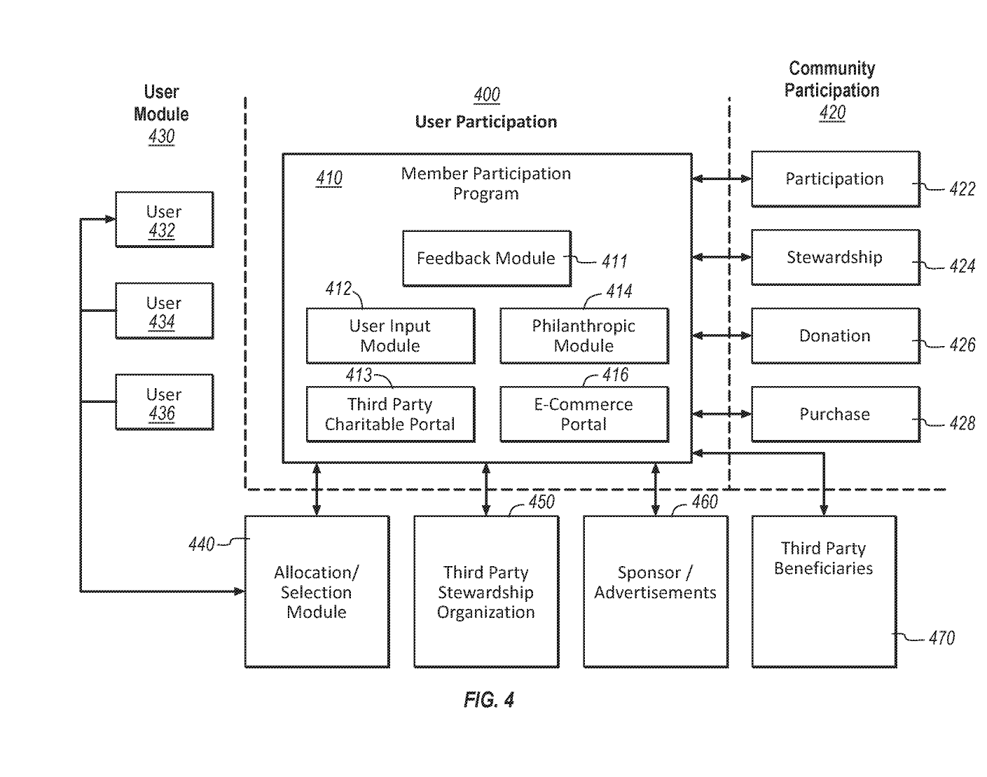

FIG. 4 illustrates a conceptual design of a member participation program module 400 of a social media platform according to one aspect of the present invention. In the illustrated embodiment, a schematic of the member participation program module 400 is depicted. Member participation program module 400 includes a membership participation program 410, a community participation module 420 and a user module 430. According to one aspect of the present invention, membership participation program 410 provides a mechanism for monitoring and providing encouragement of a user's participation in the field of outdoors, fishing, hunting and conservation by allowing a user to track, post and otherwise provide encouragement. In the illustrated embodiment, member participation program 410 includes a feedback module 411, a user input module 412, a third party charitable portal 413, a philanthropic module 414 and an e-commerce portal 416.

Member participation program 410 allows a user to directly post activities, photos, diary entries, or input information related to activities in the field of outdoor recreation. It may also work in collaboration with other business-to-business systems related to the system. For example, if a user purchases a product advertised on the social media platform, by hyperlinking to the purchase through the user's account, the system may automatically record loyalty points using e-commerce portal. Alternatively, if the user purchases a membership for an approved conservation organization, affiliation of the conservation organization with the user automatically records conservation points to the user's account using third party charitable portal 413. If a user posts a photo or comment about a recent hiking trip, the system can automatically record loyalty points using user input module 412. If a user makes a large donation to an important project, those points can be recorded using philanthropic module 414.

As will be appreciated by those skilled in the art, a variety of types and configurations of a member participation program can be utilized without departing from the scope and spirit of the present invention. For example, in one embodiment, one or more of user input module, philanthropic module, third party charitable portal and e-commerce portal reside on the social media platform and are independent of communications with third parties. In another embodiment, one or more of user input module, philanthropic module, third party charitable portal and e-commerce portal reside on the social media platform and are provided by communications with third parties, software applications or interfaces. In yet another embodiment, one or more of user input module, philanthropic module, third party charitable portal and e-commerce portal reside on the social media platform and are provided in collaboration with functionality resident on the e-commerce portal but can be communications or receive data from third parties with third parties, software applications or interfaces.

Community participation module 420 monitors specific types of activities in the field of involvement with the outdoor recreation community, local geophysical area or the like. In the illustrated embodiment, community participation module 420 includes a participation interface 422, a stewardship interface 424, a donation interface 426 and a purchase interface 428. Participation interface 422 can monitor a user's interaction and activity on social media platform in terms of posting photos, videos, journal entries, comments and other activity. Participation interface 422 relays this activity to user input module 412.

Stewardship interface 424 can monitor a user's information related to conservation activities, purchasing of products, which give back to wildlife conservation or the like. Stewardship interface relays this activity to third party charitable portal 413. In at least one implementation, the Stewardship interface 424 may comprise a validating interface API for validating a user's activities that are performed outside the social network.

For example, the validating interface API can be configured to receive indications that the user-behavior value associated with a user should be incremented by a particular value (also referred to herein as a user-behavior value increment”). The validating interface API may receive the communication from third-party. The network communication may comprise a third-party identifier, a value, and a value type. The stewardship module 424 can forward the third-party identifier, value, and value type to the third party charitable portal 413. The third party charitable portal 413 can then validate the received third-party identifier against a list of eligible third parties 450. In at least one implementation, this validation can comprise verifying that the third-party identifier comprises a predetermined secret token. In an alternate embodiment, this validation can comprise accessing an API at a remote server maintained by the third-party 450 and validating the received communication against data stored at the remote server.

After the third-party charitable portal 413 has validated the third party, the third-party charitable portal 413 can identify within a value-type dataset a data element that is associated with the received value type. For example, the value type may comprise an identifier associated with a specific service project, a specific type of service project, a specific political campaign, or some other specific event. The value-type dataset may also comprise data elements that include a value multiplier for each respective value type.

The third-party charitable portal 413 can then send the value multiplier and the value received from the stewardship module 424 to the allocation/selection module 440. The allocation/selection module 440 can then generate the user-behavior value increment by multiplying the received value with the value multiplier. This value can then be added to a user-behavior value associated with the user electronic account 432-436 of interest.

Donation interface 426 can monitor a user's financial, time, or in-kind donations to charitable causes. Donation interface 426 relays this information to philanthropic module 414. Purchase interface 428 monitors a user's purchases, transactions or other activity with respect to goods or services advertised on the social media platform, e-commerce portals associated with the social media platform, sponsors of the platform, approved conservation organizations or charities or other affiliates of the social media platform. Purchase interface 428 is affiliated with e-commerce portal 416.

User module 430 affiliates the activities of specific users with activities for which loyalty points are provided. In the illustrated embodiment, a first user 432, a second user 434, a third user 436 are depicted. As will be appreciated by those skilled in the art, the number of users will be utilized based on those who are part of the loyalty program. User module 430 also includes an allocation/selection module 440, a third party stewardship organization module 440, a sponsor/advertiser module 460 and a 3rd party beneficiary module 470. In this manner, activities that relate to users, third parties, sponsors or affiliates can be monitored and coordinated through the member participation program module 400.

For example, if first user 432, posts social media content, this information is monitored with member participation program module 410 using participation interface 422 and user input module 412. Loyalty points or other rewards are then allocated to the user using allocation selection module 440. Alternatively, if the second user 434 participates in a project to plant trees or restore a watershed, stewardship interface 424 can interact with third party charitable portal 413 to reward points using allocation/selection module 440.

Similarly if the third user 436 makes a purchase of a sponsor of social media platform or makes a financial contribution to an outdoor charity, donation interface 426 and/or purchase module 428 can interface with philanthropic module 414 and/or e-commerce portal 416 and allocation/selection module 440 to allocate loyalty points or other rewards to the user. In this manner, use of social media platform and/or altruistic behavior by users of the system can be encouraged and rewarded.

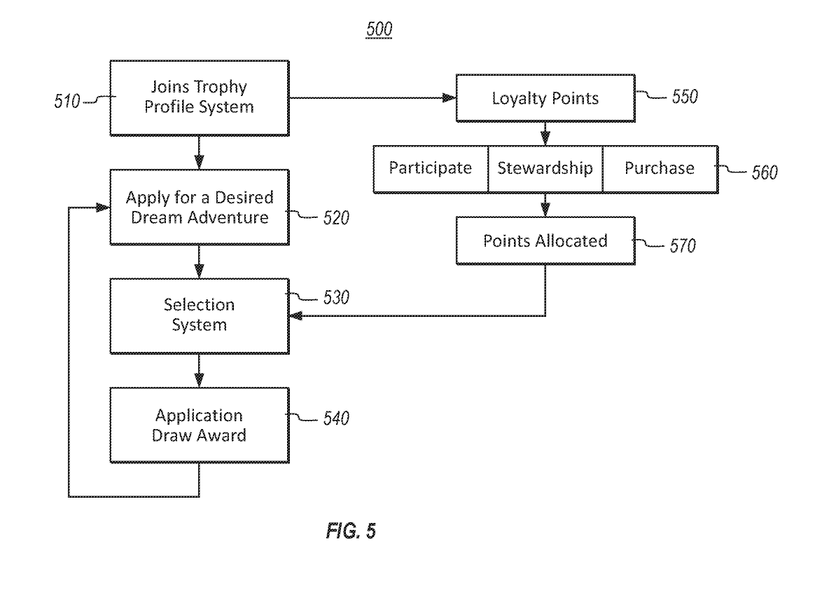

FIG. 5 illustrates a logic flow diagram depicting a method of allocating resources according to one aspect of the present invention. In the illustrated embodiment, a user joins trophy profile system in a first step 510. The user can then apply for a desired dream adventure or product in subsequent step 520. The user builds loyalty points or reward points in a step 550. The user can augment the number of points through participation, stewardship, purchases or other activities related to social media platform or altruistic behavior in a step 560. Points are allocated to the user in a step 570.

Selection system 530 then selects a drawing winner for a dream adventure or product using weighted information provided in a step 530. The application drawing is awarded in a step 540. The user can then apply for additional dream hunts or adventures once again in a step 520. As will be appreciated by those skilled in the art, a variety of types and configurations of systems for allocating points, applying for rewards and allocating awards can be provided without departing from the scope and spirit of the present invention. For example, in the illustrated embodiment, rewards such a gifts, discounts and/or memberships can be provided to each and every member. In another embodiment, a user can apply only for those rewards that the user desires. In yet another embodiment, a user can automatically be entered for drawings that are associated with products or services, which relate to attribute data indicative of the user's interests. In yet another embodiment, the user can apply a user defined number of loyalty points to enter a given drawing or give-away.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes, which come within the meaning and range of equivalency of the claims, are to be embraced within their scope.

I claim:

1. A computer system for intelligently distributing a quantifiable resource among a group of electronic accounts comprising:
one or more processors; and
one or more computer-readable media having stored thereon executable instructions that are executable by the one or more processors to configure the computer system to perform at least the following:
store within a user database one or more electronic accounts that are created by users, wherein the electronic accounts comprise a first data object that includes information descriptive of each respective user and a second data object that includes a user-behavior value;
receive through a validating interface API an indication that the user-behavior value associated with a user should be incremented by a user-behavior value increment, wherein the validating interface API is configured to:
receive a network communication from a remote third-party computer system, wherein the network communication comprises a third-party identifier, a value, and a value type,
validate the third-party identifier against a list of eligible third-parties,
after validating the third-party, identify within a value-type dataset a data element that is associated with the received value type, wherein the data element comprises a value multiplier,
generate the user-behavior value increment by multiplying the received value with the value multiplier, and
increment the user-behavior value by the user-behavior value increment;
receive from the user, associated with a particular electronic account, an indication of a particular geographic region and a particular desired objective;
access, within a resource tracking database, a resource indicator that comprises data objects that correlate to both the particular geographic region and the particular desired objective;
identify a scarcity factor associated with the resource indicator, wherein the scarcity factor indicates a number of available slots associated with the resource indicator; and
determine whether the user receives an available slot by calculating a randomized drawing value that is weighted by the user behavior value that is associated with the user's electronic account.

2. A method implemented at a computer for intelligently distributing a quantifiable resource among a group of electronic accounts, the method comprising:
storing within a user database one or more electronic accounts that are created by users, wherein the electronic accounts comprise a first data object that includes information descriptive of each respective user and a second data object that includes a user-behavior value;
receiving through a validating interface API an indication that the user-behavior value associated with a user should be incremented by a user-behavior value increment, wherein the validating interface API is configured to:
receive a network communication from a remote third-party computer system, wherein the network communication comprises a third-party identifier, a value, and a value type,
validate the third-party identifier against a list of eligible third-parties,
after validating the third-party, identify within a value-type dataset a data element that is associated with the received value type, wherein the data element comprises a value multiplier,
generate the user-behavior value increment by multiplying the received value with the value multiplier, and
increment the user-behavior value by the user-behavior value increment;
receiving from the user, associated with a particular electronic account, an indication of a particular geographic region and a particular desired objective;
accessing, within a resource tracking database, a resource indicator that comprises data objects that correlate to both the particular geographic region and the particular desired objective;
identifying a scarcity factor associated with the resource indicator, wherein the scarcity factor indicates a number of available slots associated with the resource indicator; and
determining whether the user receives an available slot by calculating a randomized drawing value that is weighted by the user behavior value that is associated with the user's electronic account.

3. A computer program product comprising one or more hardware storage devices having stored thereon computer-executable instructions that are executable by one or more processors of a computer system and that configure the computer system to intelligently distributing a quantifiable resource among a group of electronic accounts, including computer-executable instructions that configure the computer system to perform at least the following:
store within a user database one or more electronic accounts that are created by users, wherein the electronic accounts comprise a first data object that includes information descriptive of each respective user and a second data object that includes a user-behavior value;
receive through a validating interface API an indication that the user-behavior value associated with a user should be incremented by a user-behavior value increment, wherein the validating interface API is configured to:
receive a network communication from a remote third-party computer system, wherein the network communication comprises a third-party identifier, a value, and a value type,
validate the third-party identifier against a list of eligible third-parties,
after validating the third-party, identify within a value-type dataset a data element that is associated with the received value type, wherein the data element comprises a value multiplier,
generate the user-behavior value increment by multiplying the received value with the value multiplier, and
increment the user-behavior value by the user-behavior value increment;
receive from the user, associated with a particular electronic account, an indication of a particular geographic region and a particular desired objective;
access, within a resource tracking database, a resource indicator that comprises data objects that correlate to both the particular geographic region and the particular desired objective;
identify a scarcity factor associated with the resource indicator, wherein the scarcity factor indicates a number of available slots associated with the resource indicator; and
determine whether the user receives an available slot by calculating a randomized drawing value that is weighted by the user behavior value that is associated with the user's electronic account.
